(19) United States
(12) Patent Application Publication
(10) Pub. No.: US 2005/0256950 A1
(43) Pub. Date: Nov. 17, 2005

(54) Three-dimensional model data-providing program, three-dimensional model data-providing server, and three-dimensional model data transfer method

(75) Inventor: Hidetoshi Suzuki, Shizuoka (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/958,085

(22) Filed: Oct. 4, 2004

(30) Foreign Application Priority Data
Mar. 30, 2004 (JP) 2004-097391

(51) Int. Cl. G06F 15/173

(52) U.S. Cl. 709/223

(57) ABSTRACT

A three-dimensional model data-providing program which is capable of transferring image data by an appropriate one of data transfer methods, suited to the situation. When an application program delivers an instruction for drawing an image of the model, processing times are calculated which a command method and a differential image method will take to draw the image on the client, to select one which will take a shorter time. When the command method is determined to take a shorter time, data defining the model based on the instruction and data defining a display method for displaying the model are transmitted to the client. When the differential image method is determined to take a shorter time, a two-dimensional projected image is generated from the model based on the instruction and a differential image between the generated projected image and an immediately preceding projected image are transmitted to the client.

### CROSS-REFERENCE TO RELATED APPLICATIONS

This application is based on, and claims priority to, Japanese Application No. 2004-097391, filed Mar. 30, 2004, in Japan, and which is incorporated herein by reference.

### BACKGROUND OF THE INVENTION

1. Field of the Invention

This invention relates to a three-dimensional model data-providing program, a three-dimensional model data-providing server, and a three-dimensional model data transfer method, for transferring image data over a network, and more particularly to a three-dimensional model data-providing program, a three-dimensional model data-providing server, and a three-dimensional model data transfer method, which are equipped with a plurality of data transfer capabilities based on respective data transfer methods.

2. Description of the Related Art

Recently, many of recent computers are capable of drawing a three-dimensional model in a virtual three-dimensional space in real time. For example, a virtual camera that is provided in a virtual space for observing a three-dimensional model created by three-dimensional CAD (Computer-Aided Design) can be moved according to operating inputs by a user, to thereby cause the three-dimensional model to be displayed on a screen in real time according to the position and orientation of the virtual camera.

However, when a large-sized three-dimensional model is to be designed, the amount of data of the model is enormous. Moreover, if the model is composed of a plurality of component models, the three-dimensional model can be formed through cooperative work by a plurality of operators. In such a case, it can be assumed that data of the three-dimensional model is stored on a server to share the data among the operators.

Furthermore, when the three-dimensional model is created by using multifunction application software for creating three-dimensional models, the application software can be installed only on the server. In this case, a client carries out remote access to the server to thereby make use the capabilities of the application software. If the three-dimensional model data and the application software are thus managed on the server, it is possible for an administrator of the system to save the troublesome maintenance of the system. Hereinafter, the client who makes use of the application software stored on the server for three-dimensional processing is referred to as the “remote client”.

The remote client transmits a request to the application software on the server, to have data processed by the capabilities thereof, and receives the data processed by the application software to display the processed data on the screen. The techniques for displaying data processed by servers can be largely classified into two different techniques.

The first technique is a so-called X Protocol employed by Unix (registered trademark of the Open Group) and Linux (registered trademark of Unicode, Inc.).

The second technique is a so-called RDP (Remote Desktop Protocol) employed by Windows (registered trademark of Microsoft Corporation).

In the X Protocol, information for being displayed is transmitted as drawing commands. The remote client interprets the drawing commands and draws a picture on the screen based on the interpretation (see e.g. X.org, “The X Protocol”, [online], [retrieved on Mar. 5, 2004], the Internet<URL: http://www.x.org/ X11_protocol.html>). Hereinafter, the method described above is referred to as the “command method”.

In the RDP, information for being displayed is transmitted as information of the difference between image data for transmission. The remote client updates the currently displayed screen based on the transmitted information of the difference (see Microsoft, “Windows 2000 Solution Guide”, [online], [retrieved on Mar. 5, 2004], the Internet<URL: http://download.microsoft.com/ download/6/1/e/61e83440-a701-4a39-803b-df83837fbf2d/1204-UZ1.pdf>. Hereinafter, this method is referred to as the “differential image method”.

The above-described techniques are applied to all images displayed on screen, and hence in drawing or displaying three-dimensional images, they are also processed according the methods.

However, the conventional techniques have the following advantages and disadvantages:

[Amount of Data Transferred Over the Network]

There is a high possibility that the command method can cope with a change in a large area by transferring a small amount of data. For example, when processing of filling the whole screen with a certain pattern is performed, it is possible to display the result of the processing on the screen of the remote client by transferring a small amount of data from the server to the client. However, the command method is disadvantageous in that when the result of execution of lots of drawing operations in a small area is to be displayed, the amount of data to be transferred by the command method becomes larger than that of data to be transferred by the differential image method.

The performance of the differential image method becomes lower when a large area is changed, since the amount of data transferred by the differential image method is increased. However, in the differential image method, when the result of execution of lots of drawing operations in a small area is to be displayed, the amount of data to be transferred becomes smaller than that of data to be transferred by the command method.

[Drawing Speed]

In the command method, drawing or rendering of an image is carried out by the remote client, and hence the drawing speed of the command method depends on the performance of the client computer (however, in drawing a three-dimensional image by the command method, the client computer can make use of a 3D graphic accelerator).

In the differential image method, the remote client is only required to display a differential image between the immediately preceding image and the present image, and hence the drawing speed by the differential image method is not much dependent on the performance of the client computer (however, in drawing a three-dimensional image by the differential image method, the client computer cannot make use of a 3D graphic accelerator).

[Load on the Server]

In the command method, drawing load on the server is small.

In the differential image method, drawing load on the server is large.

As can be seen from the above, the data transfer method which is more efficient in transferring data depends on the situation. More specifically, although both of the methods can exhibit excellent performances in specific environments, the amount of data transferred by either of them becomes excessively large depending on the situation. What is more, in the differential image method, drawing load on the server sometimes becomes too large. This means that the conventional techniques are not satisfactory in respect of performance (particularly, in processing speed) if they are applied without any modification or configuration.

Under such circumstances, there is a demand for increasing the display speed of three-dimensional images, such that the display speed is not dependent on the situation. Particularly with three-dimensional images, the result of rotation or motion of a three-dimensional shape is frequently displayed. Therefore, the performance of the application in processing such operations has a large influence on the user-noticeable enhancement or degradation of the whole performance of the application. This makes it important to enhance the performance in processing such operations.

### SUMMARY OF THE INVENTION

The present invention has been made in view of the above points, and an object thereof is to provide a three-dimensional model data-providing program, a three-dimensional model data-providing server, and a three-dimensional model data transfer method, which are capable of transferring image data by an appropriate one of data transfer methods, which is suited to the situation.

To attain the above object, in a first aspect of the invention, there is provided a three-dimensional model data-providing program that is used when a computer provides image-drawing data for drawing images of a three-dimensional model to a client connected thereto via a network. This three-dimensional model data-providing program is characterized by causing the computer to function as three-dimensional model-forming means for forming the three-dimensional model in response to a request from the client, and delivering a drawing instruction for drawing an image of the three-dimensional model, data transfer method-determining means for calculating, based on the drawing instruction, processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency, command method-based transfer means for transferring data defining the three-dimensional model based on the drawing instruction, and data defining a display method for displaying the three-dimensional model, to the client, by the command method, when it is determined that the command method is the more efficient in processing efficiency, and differential image method-based transfer means for generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.

To attain the above object, in a second aspect of the invention, there is provided a three-dimensional model data-providing server for providing image-drawing data for drawing images of a three-dimensional model to a client connected thereto via a network. This three-dimensional model data-providing server is characterized by comprising three-dimensional model-forming means for forming the three-dimensional model in response to a request from the client, and delivering a drawing instruction for drawing an image of the three-dimensional model, data transfer method-determining means for calculating, based on the drawing instruction, processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency, command method-based transfer means for transferring data defining the three-dimensional model based on the drawing instruction, and data defining a display method for displaying the three-dimensional model, to the client, by the command method, when it is determined that the command method is the more efficient in processing efficiency, and differential image method-based transfer means for generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.

To attain the above object, in a third aspect of the invention, there is provided a three-dimensional model data transfer method for providing image-drawing data for drawing images of a three-dimensional model to a client connected thereto via a network. This three-dimensional model data transfer method is characterized by comprising a three-dimensional model-forming step of forming the three-dimensional model in response to a request from the client, and delivering a drawing instruction for drawing an image of the three-dimensional model, a data transfer method-determining step of calculating processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency, a command method-based transfer step of transmitting data defining the three-dimensional model based on the drawing instruction, and data defining a display method for displaying the three-dimensional model, to the client, by the command method, when it is determined that the command method is the more efficient in processing efficiency, and a differential image method-based transfer step of generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic diagram showing the concept of the present invention applied to an embodiment thereof;

FIG. 2 is a diagram showing an example of a system configuration of the embodiment;

FIG. 3 is a diagram showing an example of a hardware configuration of a server;

FIG. 4 is a block diagram illustrating the processing capabilities of the server;

FIG. 5 is a diagram showing information stored in a data storage section;

FIG. 6 is a flowchart showing the procedure of an image data transfer process;

FIG. 7 is a conceptual diagram useful in explaining processing performed for transmission of image-drawing data;

FIG. 8 is a diagram showing differences in transmitted image data;

FIG. 9 is a diagram showing an example of the format of image-drawing data transmitted by the command method;

FIG. 10 is a diagram showing an example of a display list;

FIG. 11 is a diagram showing an example of the format of image-drawing data transmitted by the differential image method; and

FIG. 12 is a diagram useful in explaining efficiencies of the two data transfer methods in association with the size of a three-dimensional model and processing performance of a remote client.

### DESCRIPTION OF THE PREFERRED EMBODIMENTS

The present invention will now be described in detail with reference to the accompanying drawings showing a preferred embodiment thereof.

First, the outline of the invention applied to the embodiment will be described, and then a description will be given of details of the embodiment.

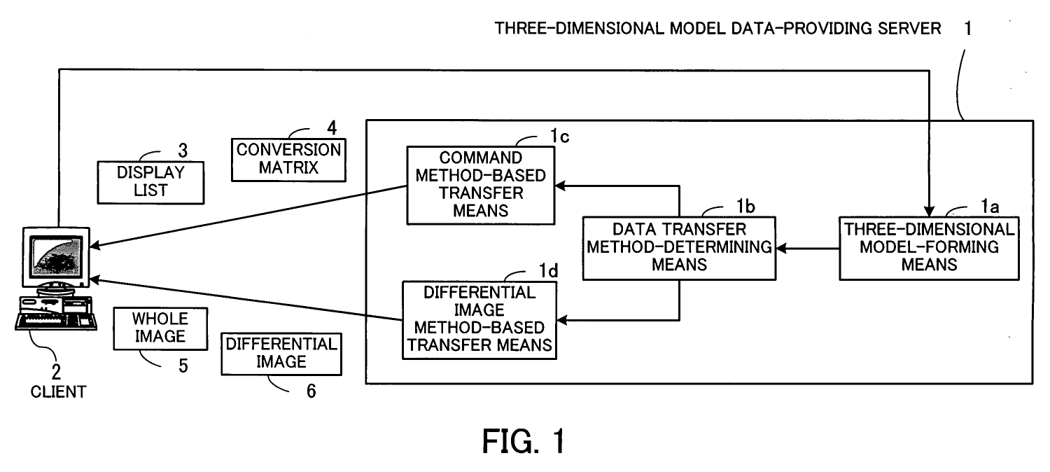

FIG. 1 is a schematic diagram of the concept of the present invention applied to the embodiment. As shown in FIG. 1, a three-dimensional model data-providing server 1 includes command method-based transfer means 1c, differential image method-based transfer means 1d, three-dimensional model-forming means 1a, and data transfer method-determining means 1b.

The three-dimensional model-forming means 1a is responsive to a request from a client 2, for forming a three-dimensional model and delivering a drawing instruction for drawing an image of the three-dimensional model. For example, the three-dimensional model-forming means 1a has capabilities, such as those of three-dimensional CAD, of drawing and editing a three-dimensional model in a virtual three-dimensional space.

The data transfer method-determining means 1b calculates processing time periods which the command method and the differential image method will take, respectively, to draw the image on the client 2, based on the drawing instruction, and determines which of the two data transfer methods will take shorter processing time periods to draw images on the client 2. For example, the data transfer method-determining means 1b hooks an API (Application Program Interface) for three-dimensional drawing, and monitors the flow of drawing instructions. Further, the data transfer method-determining means 1b checks the use of display lists, and selects a data transfer method which will be able to attain the more enhanced performance in a following sequence of operations. Timing in which the data transfer method is selected is e.g. timing in which a three-dimensional image is once cleared.

As a result of the determination, if the command method is expected to take shorter processing time periods to draw images on the client 2, the data transfer method-determining means 1b passes the drawing instructions to the command method-based transfer means 1c, whereas if the differential image method is expected to take shorter processing time periods to draw the images on the client 2, the data transfer method-determining means 1b passes the drawing instructions to the differential image method-based transfer means 1d.

The command method-based transfer means 1c transmits data defining a three-dimensional model based on a drawing instruction and data defining a display method of displaying the three-dimensional model, to the client 2, by the command method. For example, when the client 2 is equipped with a mechanism (hereinafter referred to as a “display list” after the corresponding term of OpenGL (registered trademark of SGI) capable of repeatedly utilizing data once transferred in the following display operations, first, the command method-based transfer means 1c transmits a display list 3 as the data defining a three-dimensional model. Then, the command method-based transfer means 1c sequentially transmits conversion matrices 4, such as ones associated with the positions of a virtual camera instructed by respective drawing instructions, as the data defining a display method. The client 2 recognizes the shape of the three-dimensional model based on the display list 3. Then, the client 2 converts the coordinates of vertices constituting the three-dimensional model using each conversion matrix 4 to thereby generate a corresponding two-dimensional projected image. Thus, images of the three-dimensional model as viewed from a desired direction are sequentially generated.

The differential image method-based transfer means 1d generates a two-dimensional projected image from the three-dimensional model based on a drawing instruction, and transmits a differential image or difference between the generated projected image and the immediately preceding projected image to the client 2. For example, a whole image 5 is transmitted first, and thereafter, differential images 6 are sequentially transmitted. The client 2 displays the whole image 5, and then replaces a part of the whole image 5 by each differential image 6 corresponding to the part, whenever it is received.

According to the three-dimensional model data-providing program described above, the three-dimensional model-forming means 1a forms a three-dimensional model in response to a request from the client 2, and delivers drawing instructions for drawing images of the three-dimensional model. Then, the data transfer method-determining means 1b calculates, based on the drawing instructions, processing time periods which the command method and the differential image method will take, respectively, to draw images on the client 2, and determines which of the two data transfer methods will take shorter processing time periods to draw the images on the client 2.

When the command method is determined to take shorter processing time periods to draw the images on the client 2, the drawing instructions are passed to the command method-based transfer means 1c. Then, data defining the three-dimensional model based on a drawing instruction and data (e.g. a conversion matrix 4) defining a display method of displaying the three-dimensional model are transmitted to the client 2 by the command method. The client 2 generates a two-dimensional projected image from the three-dimensional model by the command method, and displays the projected image (i.e. draws the image).

Further, when the differential image method is determined to take shorter processing time periods to draw the images on the client 2, the drawing instructions are passed from the data transfer method-determining means 1b to the differential image method-based transfer means 1d. Then, a two-dimensional projected image is generated from the three-dimensional model based on a drawing instruction by the differential image method-based transfer means 1d, and the differential image 6 between the generated projected image and the immediately preceding projected image is transmitted to the client 2. Whenever the client 2 receives the differential image 6, the client 2 replaces a corresponding part of the whole image 5 by the differential image 6, and displays the same on the screen (i.e. draws the image).

As described above, the processing time period of each data transfer method is calculated according to the contents of the drawing instructions, and image-drawing data is transferred by the data transfer method which will take a shorter processing time period to draw or display the image on the client. This makes it possible to efficiently transfer data by an optimum data transfer method suited to the operating environment.

The present invention described above can be applied to a system in which a server stores an existing stand-alone application as it is to run the same thereon, and a remote client computer (remote client) performs input and output processes of the application running on the server over a network.

It should be noted that when a large number of remote clients are connected to the server, the power for displaying a three-dimensional model varies from one remote client to another. Further, the speed of communication between the server and the remote client over the network also varies from one remote client to another. Therefore, when a large indefinite number of remote clients are expected to be connected to the server, it is required to provide the system with the capability of notifying the server of the performance of each client in advance. For example, when connection between a client and the server is established, information of the image-drawing performance on the client side and the performance of the network are transmitted to the server, for use in selection between the data transfer methods.

Hereinafter, the embodiment of the present invention will be described in detail by taking the case where data of a three-dimensional model is transferred from the server to a large indefinite number of remote clients, as an example.

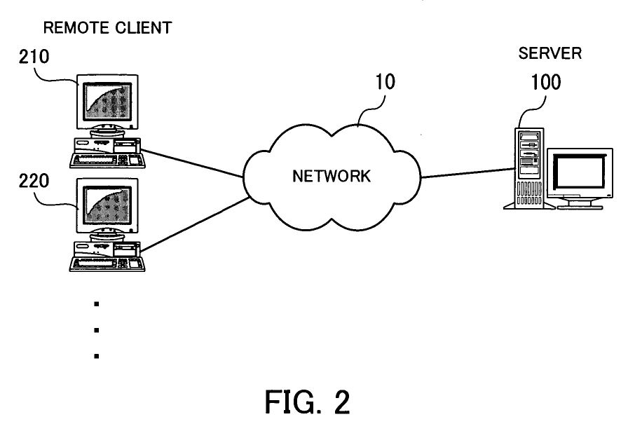

FIG. 2 shows an example of a system configuration of the present embodiment. A server 100 according to the present embodiment is connected to remote clients 210, 220, . . . The server 100 provides the capability of editing three-dimensional data and like capabilities to the remote clients 210, 220, . . . over the network 10.

The server 100 is capable of transmitting information for updating the displayed state of a three-dimensional model, by both of the command method and the differential image method. The remote clients 210, 220, . . . are capable of receiving the information and drawing the three-dimensional model, by both of the command method and the differential image method.

Further, the server 100 automatically switches between the two data transfer methods, by taking into account the performance of each of the remote clients 210, 220, . . . , the performance of the network, the amount of data to be transferred, and whether or not display lists are to be used, so as to make it possible to always ensure the optimum performance.

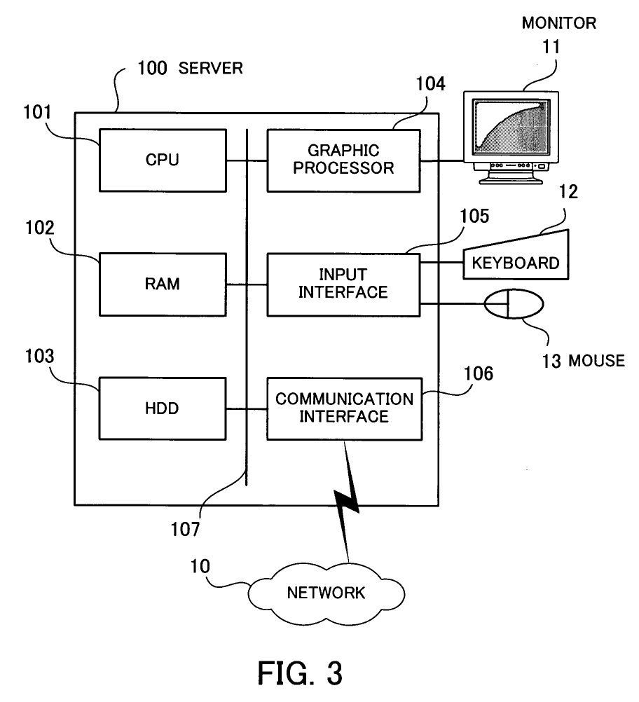

FIG. 3 is a diagram showing an example of the hardware configuration of the server. The overall operation of the apparatus implementing the server 100 is controlled by a CPU (Central Processing Unit) 101. A RAM (Random Access Memory) 102, a hard disk drive (HDD) 103, a graphic processor 104, an input interface 105, and a communication interface 106 are connected to the CPU 101 via a bus 107.

The RAM 102 temporarily stores at least part of an OS (Operating System) and application programs executed by the CPU 101. Further, the RAM 102 stores various data necessitated in processing by the CPU 101. The HDD 103 stores the OS and the application programs.

The graphic processor 104 is connected to a monitor 11. The graphic processor 104 displays an image on the screen of the monitor 11 in response to commands from the CPU 101. A keyboard 12 and a mouse 13 are connected to the input interface 105. The input interface 105 sends signals input from the keyboard 12 and the mouse 13 to the CPU 101 via the bus 107.

The communication interface 106 is connected to the network 10. The communication interface 106 performs transmission and reception of data to and from other computers over the network 10.

The hardware configuration described above can realize the processing capabilities of the present embodiment. Although FIG. 3 shows the example of the hardware configuration of the server 100, it is also possible to realize the remote clients 210, 220, . . . by the same hardware configuration.

However, as the graphic processors of the remote clients 210, 220, . . . , there are employed those capable of drawing a three-dimensional image in real time. More specifically, the graphic processors of the remote clients 210, 220, . . . can generate two-dimensional projected images by projecting an object defined by three-dimensional coordinates onto a screen. Further, the graphic processors of the remote clients 210, 220, . . . each have two image buffers and is capable of displaying moving images in real time by writing each three-dimensional image alternately into the two image buffers.

In the following, the processing capabilities of the present embodiment will be described in detail by taking the case where the three-dimensional image processing capability of the server 100 is made use of by the remote client 210, as an example.

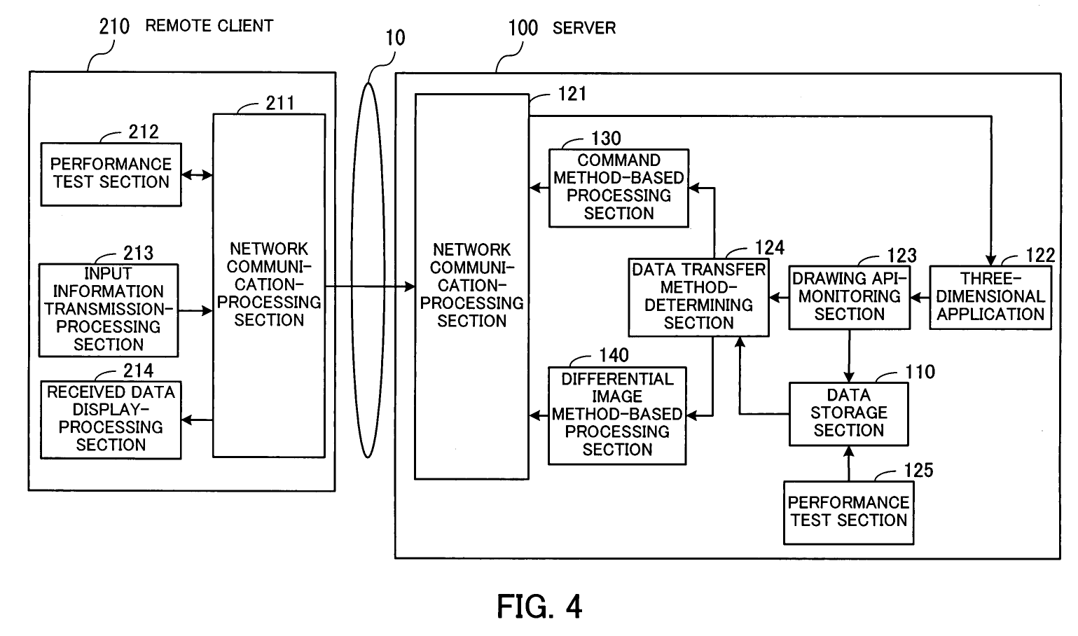

FIG. 4 is a block diagram illustrating the processing capabilities of the server. The server 100 is comprised of a data storage section 110, a network communication-processing section 121, a three-dimensional application 122, a drawing API-monitoring section 123, a data transfer method-determining section 124, a performance test section 125, a command method-based processing section 130, and a differential image method-based processing section 140. Further, the remote client 210 includes a network communication-processing section 211, a performance test section 212, an input information transmission-processing section 213, and a received data display-processing section 214.

The data storage section 110 stores information required for transmitting images to the remote client 210.

The network communication-processing section 121 performs communications between the server 100 and the remote client 210. More specifically, when receiving input information of details of an operating input to the remote client 210 performed by the user, the network communication-processing section 121 passes, the input information to the three-dimensional application 122. Also, the network communication-processing section 121 transmits information received from the command method-based processing section 130 or the differential image method-based processing section 140 to the remote client 210.

The three-dimensional application 122 performs three-dimensional image processing. For example, the three-dimensional application 122 is for the three-dimensional CAD (Computer-Aided Design). More specifically, the three-dimensional application 122 carries out image processing and the like according to the input information received from the network communication-processing section 121, and delivers the result of the image processing by using the drawing API (Application Program Interface).

The drawing API-monitoring section 123 hooks data of the drawing API for drawing three-dimensional images (process for obtaining output data) to monitor the flow of command data, and caches drawing commands contained in the command data in the data storage section 110. Further, the drawing API-monitoring section 123 calculates the number of polygons constituting an image of the three-dimensional model based on the drawing commands. The result of the calculation is stored in the data storage section 110. Furthermore, the drawing API-monitoring section 123 calculates the amount of data in the display list based on the drawing commands. The result of the calculation is stored in the data storage section 110. The drawing API-monitoring section 123 carries out the above processing until a clear command for clearing the image buffer is delivered from the three-dimensional application 122. Further, when the drawing API-monitoring section 123 has detected the clear command, it instructs the data transfer method-determining section 124 to determine a data transfer method for transferring the data.

The data transfer method-determining section 124 determines which of the command method and the differential image method should be used for transferring the data. More specifically, when instructed to determine a data transfer method by the drawing API-monitoring section 123, the data transfer method-determining section 124 starts the determination process, in which the section 124 calculates respective processing efficiencies of the command method and the differential image method (e.g. time periods the methods will take to display images), by referring to the information stored in the data storage section 110. Then, the data transfer method-determining section 124 determines the method having the higher processing efficiency as the data transfer method for the following data to be transferred. Information indicative of the determined data transfer method is stored in the data storage section 110. From then on, the data transfer method-determining section 124 passes command data to a processing section (the command method-based processing section 130 or the differential image method-based processing section 140) corresponding to the determined data transfer method.

The performance test section 125 executes the performance test of the server 100. The value of the performance of the server 100 measured by the performance test section 125 is stored in the data storage section 110.

The command method-based processing section 130 transfers data by the command method. In doing this, if cached data exists, the command method-based processing section 130 transmits image-drawing data including cached drawing commands to the remote client 210. For example, when a display list is used, the command method-based processing section 130 transmits the display list which shows the shape of the three-dimensional model, and image-drawing data containing drawing commands including those indicative of a display method, such as an editing method of the three-dimensional image. After that, whenever the command method-based processing section 130 receives drawing commands indicative of a display method, the section 130 sequentially transmits image-drawing data containing the drawing commands. The drawing commands indicative of a display method include a drawing command for rotating an object, for example. This drawing command for rotating an object includes a rotation matrix.

The differential image method-based processing section 140 performs data transfer by the differential image method. More specifically, when cached data exist, the differential image method-based processing section 140 draws an image into an image buffer of the server 100 according to the cached drawing commands. Further, the differential image method-based processing section 140 sequentially draws images into the image buffer according to the following drawing commands, and transmits image-drawing data containing information of an image drawn in the image buffer to the remote client 210. At this time, if the drawing commands include ones specifying a display method, such as colors and a light source, these drawing commands are also contained in the image data.

After transmitting the image data, the differential image method-based processing section 140 holds the transmitted image data, and when receiving drawing commands, it draws an image corresponding to the drawing commands, and detects the difference (changed image area) between image data to be displayed next and the immediately preceding image data. Then, the differential image method-based processing section 140 transmits an image of the changed image area, i.e. a differential image.

The remote client 210 includes the network communication-processing section 211, the performance test section 212, the input information transmission-processing section 213, and the received data display-processing section 214.

The network communication-processing section 211 performs communication with the sever 100. More specifically, the network communication-processing section 211 transmits the result of the performance test of the server 100, executed by the performance test section 212, and input information inputted from the input information transmission-processing section 213, to the server 100. Further, the network communication-processing section 211 passes image information to the received data display-processing section 214. The performance test section 212 carries out testing of the drawing performance of the remote client 210 and the performance of the network (performance tests), and notifies the server 100 of the results of the performance tests. The input information transmission-processing section 213 notifies the server 100 of input information indicative of the details of an operating input by the user. The received data display-processing section 214 performs a screen display process based on data received from the server 100.

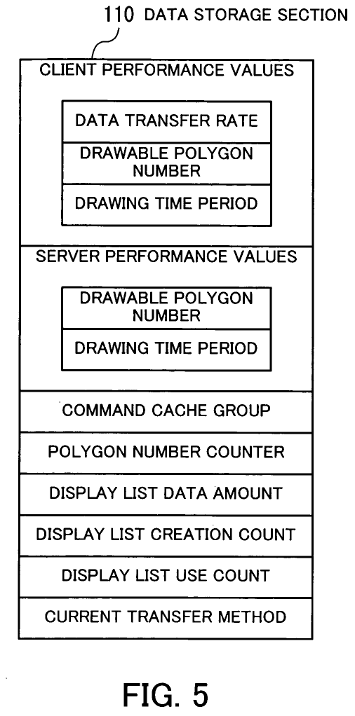

FIG. 5 shows information stored in the data storage section. In the data storage section 110, there are stored client performance values, server performance values, a command cache group, a polygon number counter, a display list data amount, a display list creation count, a display list use count, and the current transfer method.

The client performance values are information indicative of the processing power of the remote client 210. In the illustrated example, the data transfer rate, drawable polygon number, and drawing time period of the remote client 210 are registered. The data transfer rate indicates the amount of data (byte/second) which can be transferred per unit time (second) over the network between the remote client 210 and the server 100. The drawable polygon number indicates the number of polygons (number/second) which the remote client 210 is capable of drawing per unit time (second). The drawing time period indicates a time period (seconds) which the remote client 210 takes to draw the whole of one frame of image.

The server performance values are information indicative of the processing power of the server 100. In the illustrated example, the drawable polygon number and drawing time period of the server 100 are registered. The drawable polygon number indicates the number of polygons (number/second) which the server 100 is capable of drawing per unit time (second). The drawing time period indicates a time period (seconds) which the server 100 takes to draw the whole of one frame of image.

The command cache group is comprised of a plurality of commands instructing image processing, which are stored as cached data. A value indicative of the number of polygons to be drawn is set to the polygon number counter. The amount of data of a display list to be transmitted is set to the display list data amount. The number of times that a display list-creating process has been executed is set to the display list creation count. The number of times that a display list has been used is set to the display list use count. Information indicative of which of the command method and the differential image method is currently used for transferring image-drawing data is set to the current transfer method.

The system configured as above carries out the processes described hereafter. It should be noted that of the processes described below, processes executed by elements (OS and the like) other than those shown in FIG. 4 will be described assuming that they are carried out by the server 100 or the remote client 210.

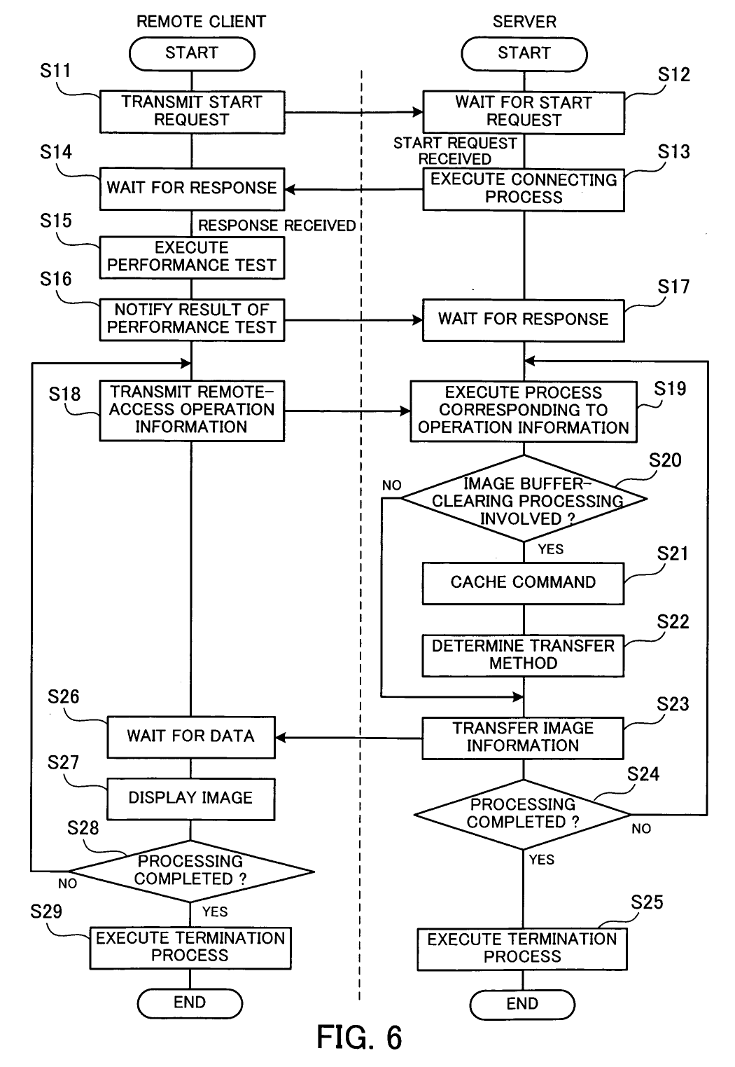

FIG. 6 is a flowchart showing the procedure of an image data transfer process. In the following, the process shown in FIG. 6 will be described in the order of step numbers.

[Step S11] When the remote client 210 is started, a start request is transmitted from the remote client 210 to the server 100.

[Step S12] When the server 100 is started, it is placed in a start request wait state for waiting for a start request from the remote client 210. Then, when the server 100 receives the start request from the remote client 210, the process proceeds to a step S13.

[Step S13]. The server 100 executes a connecting process for connection between the same and the remote client 210.

[Step S14]. After transmitting the start request to the server 100, the remote client 210 is placed in a response wait state. Then, when the remote client 210 receives a response indicative of execution of the connecting process from the server 100, the process proceeds to a step S15.

[Step S15] The performance test section 212 of the remote client 210 executes a performance test. This performance test is executed for measuring the amount of data which can be transferred to the network per unit time (data transfer rate).

[Step S16] The remote client 210 notifies the server 100 of the result of the performance test.

[Step S17] The server 100 stores the data transfer rate notified by the remote client 210 in the data storage section 110 as the data transfer rate of the client performance values.

It should be noted that respective values of the drawable polygon number and the drawing time period of the client performance values are measured by the performance test section 212, transmitted to the server 100, and stored in the data storage section 110 in advance. Further, respective values of the drawable polygon number and the drawing time period of the server performance values are measured by the performance test section 125 of the server 100 and stored in the data storage section 110 in advance.

[Step S18] The input information transmission-processing section 213 of the remote client 210 receives an operating input by the user to the three-dimensional application 122, and then transmits input information indicative of the details of the operating input to the server 100.

[Step S19] The three-dimensional application 122 of the server 100 executes the three-dimensional image processing according to the input information from the remote client 210, to thereby generate data of a three-dimensional image, and then delivers drawing commands instructing drawing of the three-dimensional image.

[Step S20] The drawing API-monitoring section 123 of the server 100 determines whether or not the drawing commands involve processing for clearing the image buffer. When the processing for clearing the image buffer is not involved, the process proceeds to a step S23, whereas when the clearing processing is involved, the process proceeds to the step S21.

For example, in the case of a specification of the system in which the image buffer is comprised of front and back buffers such that the front buffer is always used for editing an object to be drawn, it is determined that the image buffer should not be cleared if one of the buffers to be used for drawing the object is the front buffer, whereas if one of the buffers to be used for drawing the object is changed to the back buffer during the editing, it is determined that the image buffer (front and back buffers) should be cleared.

[Step S21] The drawing API-monitoring section 123 starts to cache drawing commands. More specifically, the drawing API-monitoring section 123 stores drawing commands delivered from the three-dimensional application 122 in the data storage section 110.

Further, the drawing API-monitoring section 123 starts monitoring the drawing of the three-dimensional image. In an example in which the OpenGL is used as a three-dimensional drawing library, a display list generation (glNewList/glEndList) command and a display list use (glCallList) command are checked, and the number of times of use of the generated display list is counted. The value of the count is stored in the data storage section 110.

[Step S22]. The data transfer method-determining section 124 determines a transfer method to be employed, based on the information stored in the data storage section 110. More specifically, the data transfer method-determining section 124 calculates the respective time periods over which the command method and the differential image transfer method will take to display images of the three-dimensional model, and then determines a method capable of displaying the images on the client 210 more promptly or in shorter time periods, as the transfer method for transferring image information.

[Step S23] The image information is transferred from the server 100 to the remote client 210 by the determined transfer method. More specifically, the data transfer method-determining section 124 instructs the processing capability corresponding to the determined transfer method to transfer the image information. For example, when it is determined that the image information should be transferred by the command method, the drawing commands having been cached in the data storage section 110 are passed from the data transfer method-determining section 124 to the command method-based processing section 130. Then, the command method-based processing section 130 transmits drawing commands which instruct drawing of an image by the command method, to the remote client 210. On the other hand, when it is determined that the image information should be transferred by the differential image method, the drawing commands having been cached in the data storage section 110 are passed from the data transfer method-determining section 124 to the differential image method-based processing section 140. Then, the differential image method-based processing section 140 draws and sends a whole image based on the cached drawing commands, and then sequentially sends differential images to the remote client 210.

[Step S24] The server 100 determines whether or not the three-dimensional image processing has been completed. If the processing has been completed, the present process proceeds to a step S25, whereas if the processing has not been completed, the process returns to the step S19. If the process returns to the step S19, the server 100 is placed in an operation information wait state for waiting for operation information, and when the server 100 receives the operation information from the remote client 210, the step S19 et seq. are carried out again.

[Step S25] The server 100 executes a termination process (e.g. for cutting off the communication with the remote client 210), followed by terminating the present process.

[Step S26] After transmitting the operation information, the remote client 210 is placed in a data wait state for waiting for image-drawing data, and when the remote client 210 receives the image-drawing data from the server 100, the process proceeds to a step S27.

[Step S27] The received data display-processing section 214 of the remote client 210 draws an image based on the received image-drawing data, and displays the image.

[Step S28] The remote client 210 determines whether or not the three-dimensional image processing has been completed. If the processing has been completed, the process proceeds to a step S29, whereas if the processing has not been completed, the process returns to the step S18. If the process returns to the step S18, the input information transmission-processing section 213 of the remote client 210 is placed in an operating input wait state, and when an operating input is performed by the user, the step S18 et seq. are carried out again.

[Step S29] The remote client 210 executes a termination process (e.g. for cutting off the communication with the server 100), followed by terminating the present process.

As described above, information of the performances of the remote client 210 and the server 100 and the performance of the network is obtained, and using the information, it is possible to determine the transfer method by which images can be displayed on the client 210 in shorter time periods, at a time point the processing for clearing the image buffer occurs. More specifically, the processing for determining the transfer method is executed in timing of once clearing three-dimensional data (or in timing of first performing the drawing of a three-dimensional image). At this time, it is determined which of the command method and the differential image method should be employed for transferring image-drawing data, by comparing the amount (predicted value) of data based on drawing commands and that of data based on differential images and taking the above-mentioned performances obtained in advance into account.

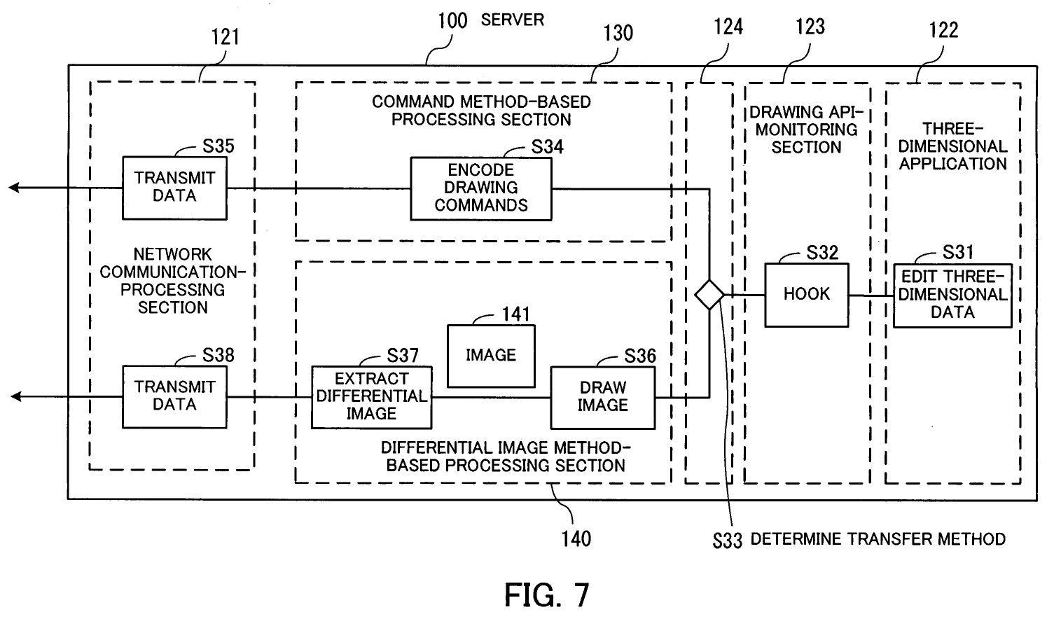

FIG. 7 is a conceptual diagram useful in explaining processing performed before transmission of image-drawing data. When three-dimensional data is edited by the three-dimensional application 122, drawing commands are delivered in a step S31. The delivered drawing commands are hooked by the drawing API-monitoring section 123 in a step S32. Then, in a step S33, a transfer method is determined by the data transfer method-determining section 124.

When the command method is determined as the transfer method, the drawing commands are passed to the command method-based processing section 130, which encodes the drawing commands in a step S34. Image-drawing data generated by encoding the drawing commands is transmitted to the remote client 210 by the network communication-processing section 121.

When the differential image method is determined as the transfer method, the drawing commands are passed to the differential image method-based processing section 140, which draws an image 141 in a step S36. Further, the differential image method-based processing section 140 extracts the difference between the generated image 141 and the immediately preceding image in a step S37. Then, out of a plurality of areas formed by dividing the image 141, areas having updated images drawn thereon are identified by the differential image method-based processing section 140, and data of the respective images (differential images) on the areas is transmitted to the remote client 210 by the network communication-processing section 121 in a step S38. After that, data continues to be transferred by the same method until it is time for once clearing the three-dimensional data. When the clearing time comes, the processing for determining the data transfer method is executed, in the same manner as described above.

Next, a detailed descriptions will be given of methods of calculating the respective processing time periods of the data transfer methods. Hereinafter, a case where the OpenGL is used as a three-dimensional drawing library will be described by way of example. In the OpenGL, timing in which three-dimensional data is once cleared is timing in which a glclear command is called. Further, in the OpenGL, after the glclear command is called, timing in which all image data have once been displayed on the screen is timing in which glFlush and SwapBuffers commands are called. By hooking all the drawing commands from the glClear command to the glFlush and SwapBuffers commands, all the commands necessary for drawing an image on the entire screen are once cached. Further, the number of polygons to be drawn is counted, and if a display list is to be used, the amount of data thereof is calculated.

The processing time periods of the respective data transfer methods are calculated by the following equations:
Command method: processing time period (seconds)=(amount of cached data (byte)/data transfer rate (byte/sec))+(number of polygons (num)/drawable polygon number of remote client (number/second))

It should be noted that if the current data transfer method is the differential image method, the amount of data of a display list (byte) is added to the amount of cached data, in calculating the processing time period of the command method.
Differential image method: processing time period (seconds)=(number of polygons (num)/drawable polygon number of server (number/second))+(amount of data (byte) required to transfer whole window×coefficient P/data transfer rate (byte/sec)+(amount of data of display list (byte)/data transfer rate (byte/sec))+drawing time period of client (seconds)×coefficient P

It should be noted that in the differential image method, it is impossible to accurately know which areas of the window are to be updated, and hence in this example, a simplified method is employed in which the amount of data required to transfer a whole window is multiplied by the coefficient P, which is set to a fixed value. The coefficient P is larger than 0 and not larger than 1 (e.g. 0.7).

Further, in the above equations, “data transfer rate (byte/second)”, “drawable polygon number of client (number/second)”, and “drawing time period of client (seconds)” are values registered in advance in the data storage section 110.

After performing the above calculations, the data transfer method-determining section 124 employs a transfer method by which the processing can be performed in a shorter time period. However, if a display list is used, the command method is selected when it can be determined from the number of times of use of the display list counted by the drawing API-monitoring section 123 that the display list is efficiently used (e.g. when the number of times of use per display list is not less than a predetermined value).

When the determined data transfer method is the command method, cached drawing commands are encoded, and transferred to the remote client 210. At this time, no image is drawn on the server side.

When the determined data transfer method is the differential image method, a three-dimensional image is drawn on the server side, and differential images of changed parts are transferred to the remote client 210. However, when there exist drawing commands specifying display modes other than those: for drawing the shape of a three-dimensional image, they are also transmitted to the remote client 210. This is because if processing for changing colors of shapes, processing for specifying a light source, or the like is executed during drawing by the differential image method, there is a fear that the client cannot recognize changed information when the differential image method is switched to the command method.

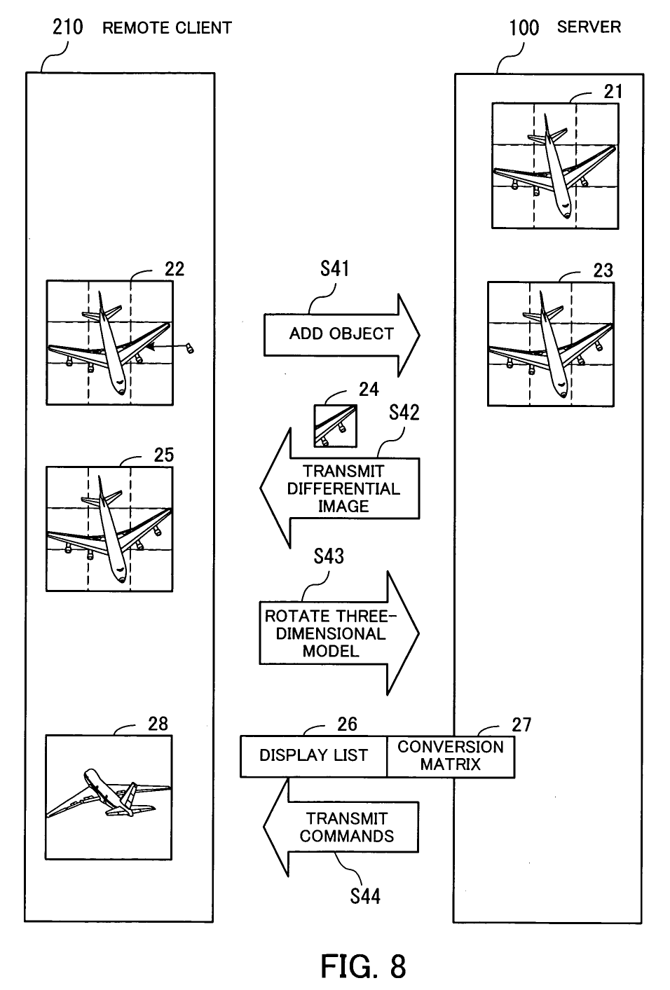

FIG. 8 shows differences in transmitted image data. In the illustrated example, it is assumed that edit operations for editing a three-dimensional model are performed by operating inputs from the remote client 210. During editing of the three-dimensional model, it is only required to update images of portions subjected to the edit operations. Accordingly, data is transferred by the differential image method.

In the differential image method, the same images 21 and 22 are held by the server 100 and the remote client 210. When an operation for adding an object to the image 22 is performed by the remote client 210, operation information indicative of the details of the operation is transmitted from the remote client 210 to the server 100 in a step S41.

The server 100 generates an image 23 having the object added thereto, according to the operation information, and detects the difference between the original image 21 and the image 23 newly generated. More specifically, the images 21 and 23 are each divided into a plurality of areas (divisional images), and it is determined on a divisional image-by-divisional image basis whether or not the image 23 is changed from the image 21. The server 100 transmits a divisional image changed from a corresponding divisional image of the image 21, as a differential image 24, to the remote client 210 in a step S42.

When receiving the differential image 24, the remote client 210 replaces a corresponding portion of the original image 22 by the differential image 24. Thus, an updated image 25 is generated, and displayed on the remote client 210.

Let it be assumed that the user subsequently instructs the rotation of the three-dimensional model. When receiving an operating input for instructing the rotation of the three-dimensional model, the remote client 210 transmits operation information indicative of the rotation of the three-dimensional model to the server 100 in a step S43. It should be noted that the start of the process for rotating the three-dimensional model involves clearing of the image buffer. Therefore, the server 100 carries out the data transfer method-determining process.

Now, assuming that the command method is selected, image-drawing data is transmitted from the server 100 to the remote client 210 by the command method in a step S44. Image-drawing data first transmitted by the command method includes a display list 26, and a conversion matrix 27. The display list 26 defines the shape and the like of a three-dimensional model to be drawn, in a virtual three-dimensional space. The conversion matrix 27 is a matrix (e.g. rotational matrix) for converting three-dimensional coordinate values according to the direction of display of the three-dimensional model (the position and orientation of a virtual camera observing the three-dimensional model).

The remote client 210 converts the three-dimensional coordinate values defined by the received display list 26 using the conversion matrix 27 to thereby project the three-dimensional model onto a two-dimensional plane, and displays the projected image 28.

Next, a description will be given of respective image data formats of the data transfer methods.

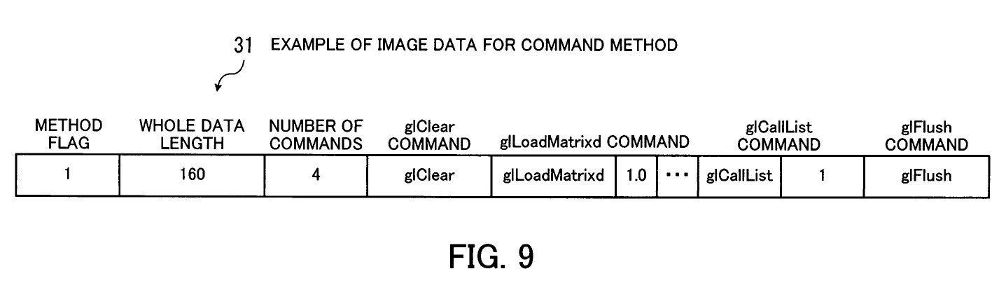

FIG. 9 is a diagram showing an example of the format of image-drawing data transmitted by the command method. Image-drawing data 31 used by the command method includes a method flag, a whole data length, the number of commands, a glclear command, a glLoadMatrixd command, a glCallList command, and a glFlush command.

The method flag is information indicative of a data transfer method. In the illustrated example, a value of 1 designates the command method. The whole data length indicates the length of the whole image-drawing data 31 in units of bytes. The number of commands indicates the number of commands contained in the image-drawing data 31. The glclear command indicates clearing of the image buffers. This command has no parameter set thereto. The glLoadMatrixd command specifies a conversion matrix. This command has 16 parameters (values of a 4×4 matrix used for coordinate conversion) set thereto. The glCallList command instructs execution of a display list. This command has a parameter designating the display list. The glFlush command forces execution of commands. This command has no parameter set thereto.

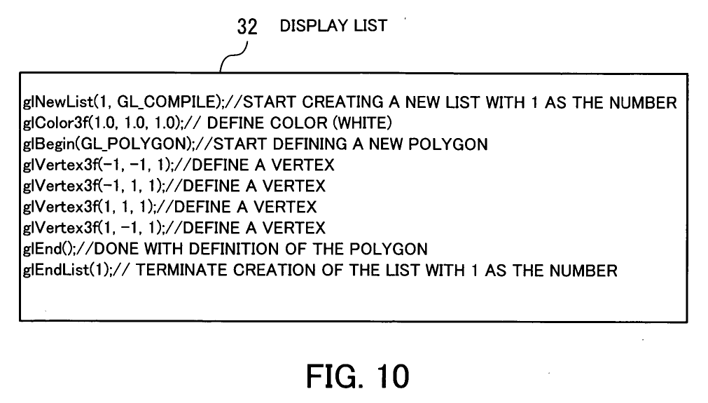

FIG. 10 is a diagram showing an example of the display list. The display list 32 defines the respective positions of the vertices of each polygon, and the color of the polygon. FIG. 10 shows an example of the display list 32 defining a quadrilateral on a plane. In FIG. 10, the symbol “glNewList(1, GL_COMPILE);” represents the start of creation of a list No. 1. The symbol “glColor3f(1.0, 1.0, 1.0);” indicates that white is used in drawing. The symbol “glBegin(GL_POLYGON);” represents the start of definition of a polygon. The symbols “glVertex3f(−1, −1, 1);”, “glVertex3f(−1, 1, 1);”, “glVertex3f(1, 1, 1);”, and “glVertex3f(1, −1, 1);” indicate the respective sets of coordinates of vertices of the quadrilateral. The symbol “glEnd( );” represents termination of the definition of the polygon. The symbol “glEndList(1);” represents termination of the creation of the list No. 1.

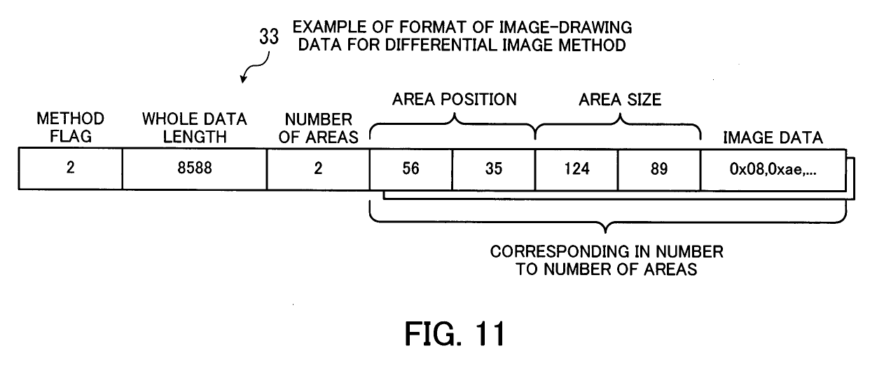

FIG. 11 a diagram showing: an example of the format of image-drawing data transmitted by the differential image method. Image data 33 used by the differential image method includes a method flag, a whole data length, the number of areas, at least one area position, at least one area size, and image data.

The method flag is information indicative of a data transfer method. In the illustrated example, a value of 2 designates the differential image method. The whole data length indicates the length of the whole image data 33 in units of bytes. The number of areas indicates the number of divisional image areas contained as differential images. The area position indicates the position of the area of a differential image by X and Y coordinates. The area size indicates the size of the area of a differential image by a horizontal size (width) and a vertical size (height). The image data represents image information of a differential image. It should be noted that the respective numbers of the at least one area position, the at least one area size, and the at least one image data are equal to the number of areas.

By the way, which of the command method and the differential image method is more efficient depends on the size of a changed image area and the system environment. The following factors of the system environment have influence on determination of the data transfer method.
performance of a remote client (particularly, the performance of a 3D graphic accelerator)
bandwidth of the network
whether or not the application is using display lists
size of a three-dimensional model

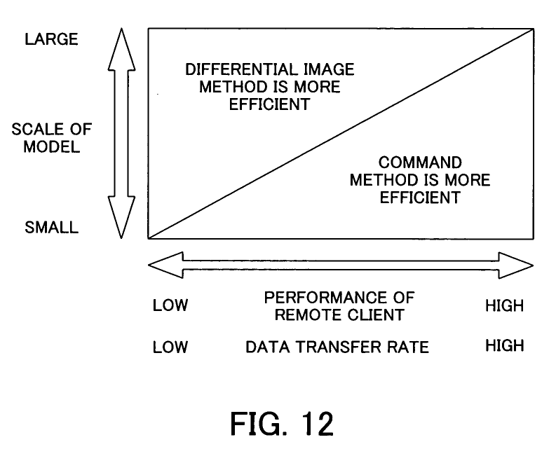

FIG. 12 is a diagram useful in explaining efficiencies of the two data transfer methods in association with the size of a three-dimensional model and processing performance of a remote client. Although points for the selection are slightly changed depending on whether or not the three-dimensional application 122 is using display lists, the tendency of the selection is as shown in FIG. 12.

As illustrated in the figure, the smaller the size of a three-dimensional model, the more efficient the command method.

Further, as the performance of the remote client is lower, the differential image method is more efficient, whereas as the performance of the remote client is higher, the command method is more efficient. Furthermore, as the data transfer rate is lower (the bandwidth is narrower), the differential image method is more efficient, whereas as the data transfer rate is higher (the bandwidth is broader), the command method is more efficient.

For example, if the user uses a remote client low in performance, the command method is employed in operating a model small in size, whereas the differential image method is employed in operating a model large in size. Further, if the user uses a remote client high in performance, in an environment where the bandwidth of the network is broad, the command method is employed irrespective of whether the size of the model is large or small.

As described hereinabove, according to the embodiment of the present invention, it is possible to use an application dealing with three-dimensional data, at the optimum speed on a remote client, according to the performance of the remote client and that of the network. In other words, it is possible to make the most of the performances of the remote client (particularly the 3D graphic accelerator) and the network.

Now, a detailed description will be given of advantageous effects of the present embodiment obtained by applying the above described capabilities thereto, with respect to “Timing for automatically switching the transfer method”, and “Taking performances into account during a sequence of operations”.

<Timing for Automatically Switching the Data Transfer Method>

To introduce a mechanism for switching the transfer method between the command method and the differential image method as desired in drawing a general image, the server 100 is required to hold the same images that is drawn on the client side. This is necessitated to display an image on the remote client side without any loss even when the transfer method is arbitrarily switched. Therefore, the image has to be drawn both on the server side and the remote client side, which is disadvantageous in respect of processing speed.

In the present embodiment, the timing for automatically switching the data transfer method is made synchronous with timing for once clearing all the data on the screen. This makes it possible for the server 100 to omit processing for drawing a three-dimensional image when the command method is selected. The performance of the server 100 is desired to be enhanced especially when a three-dimensional shape is rotated or moved. When such an operation is carried out, the server 100 once clears all the data on the screen, and then newly transfers all the three-dimensional data, or transmits matrices for rotating or moving the three-dimensional shape, as internal processing thereof. By making the timing for automatically switching the data transfer method synchronous with the timing for once clearing all the data on the screen, the server 100 can omit the processing for drawing the three-dimensional image when the command method is selected. This makes it possible to achieve significant enhancement of processing speed.

<Taking Performances into Account During a Sequence of Operations>

In selecting a data transfer method, it is determined which of the command method and the differential image method makes smaller the amount of data to be processed, by taking into account the performances of the server 100, the remote client 210, and the network 10. However, in the case of data having a three-dimensional shape, it is impossible to perform the above determination based on only the amount of data to be transferred at one time, since the three-dimensional data includes display lists. To cope with this inconvenience, in the present embodiment, the data transfer method is determined not only by paying attention to the three-dimensional data to be transferred from now but also by considering operations expected to be performed thereafter, whereby a data transfer method is selected which is expected to be most suitable for high-speed operation. To enable the determination, the drawing API-monitoring section 123 of the server 100 has the capability of monitoring the state of display lists being used. When the data transfer method-determining section 124 has determined that the display lists are to be used effectively (e.g. when the number of times of use per each generated display list is larger than a predetermined value), the data transfer method-determining section 124 selects the command method, even if the amount of data to be transferred during definition of the display lists is increased. As a result, it is possible to enhance the performance of the server 100 when a three-dimensional image is moved or rotated, thereby making it possible to carry out a sequence of operations at a higher speed than when the differential image method is employed.

It should be noted that the aforementioned processing capabilities can be realized by causing the server and the remote client to execute predetermined programs. In this case, there are provided a server program describing details of capabilities which the server should have, and a client program describing details of capabilities which the remote client should have. The processing capabilities of the server 100 are realized on a server computer by executing the server program with the server computer. Further, the processing capabilities of the remote client 210 are realized on a client computer by executing the client program with the client computer.

The sever program and client program describing the details of the processes can be recorded in a computer-readable recording medium. The computer-readable recording medium includes a magnetic recording device, an optical disk, a magneto-optical recording medium, and a semiconductor memory. The magnetic recording device includes a hard disk drive (HDD), a flexible disk (FD)), and a magnetic tape. The optical disk includes a DVD (Digital Versatile Disk), a DVD-RAM (Random Access Memory), and a CD-ROM (Compact Disk Read Only Memory), and a CD-R (Recordable)/RW (ReWritable). Further, the magneto-optical recording medium includes an MO (Magneto-Optical disk).

To make the sever program and the client program available on the market, portable recording media, such as DVD and CD-ROM, which store the program, are sold. Further, the client program can be stored in a storage device of a server computer connected to a network, and transferred from the server computer to client computers over the network.

When the server program is executed by a sever computer, the server program stored e.g. in a portable recording medium is stored into a storage device of the computer. Then, the server computer reads the server program from the storage device of its own and executes processing based on the server program. The server computer can also read the server program directly from the portable recording medium and execute processing based on the server program.

When the client program is executed by a client computer, the client program stored e.g. in a portable recording medium or transferred from a server computer is stored into a storage device of the client computer. Then, the client computer reads the client program from the storage device of its own and executes processing based on the client program. The client computer can also read the client program directly from the portable recording medium and execute processing based on the client program. Further, the client computer may also execute processing based on a client program which is transferred from the server computer whenever the processing is to be carried out.

As described hereinbefore, the present invention is configured to calculate processing time periods which the command method and the differential image method will take, respectively, to draw images i.e. display them on a remote client, and transfer image-drawing data by one of the data transfer methods which will take a shorter time period to draw the images. This makes it possible to transfer image data by the more efficient one of the two data transfer methods according to the environment.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A three-dimensional model data-providing program that is used when a computer provides image-drawing data for drawing images of a three-dimensional model to a client connected thereto via a network,
wherein the program causes the computer to function as:
three-dimensional model-forming means for forming the three-dimensional model in response to a request from the client, and delivering a drawing instruction for drawing an image of the three-dimensional model;
data transfer method-determining means for calculating, based on the drawing instruction, processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency;
command method-based transfer means for transferring data defining the three-dimensional model based on the drawing instruction, and data defining a display method for displaying the three-dimensional model, to the client, by the command method, when it is determined that the command method is the more efficient in processing efficiency; and
differential image method-based transfer means for generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.

2. The three-dimensional model data-providing program according to claim 1, wherein said data transfer method-determining means performs a process for determining the data transfer method, when a process indicated by the drawing instruction delivered from said three-dimensional model-forming means involves clearing of data of the projected image stored in an image buffer.

3. The three-dimensional model data-providing program according to claim 1, wherein said data transfer method-determining means calculates each processing time period by adding together a transfer time period which is taken to transfer data over the network and a drawing time period which is taken to draw the image of the three-dimensional model on the client.

4. The three-dimensional model data-providing program according to claim 1, wherein said differential image method-based transfer means transmits a command specifying a display mode required for drawing the image of the three-dimensional model by the command method, together with the differential image in advance.

5. The three-dimensional model data-providing program according to claim 1, wherein said data transfer method-determining means determines the command method as the data transfer method, when the data defining the three-dimensional model can be repeatedly used using the command method by the client, and if the number of times of use of the data is not less than a predetermined value.

6. A three-dimensional model data-providing server for providing image-drawing data for drawing images of a three-dimensional model to a client connected thereto via a network, comprising:
three-dimensional model-forming means for forming the three-dimensional model in response to a request from the client, and delivering a drawing instruction for drawing an image of the three-dimensional model;
data transfer method-determining means for calculating, based on the drawing instruction, processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency;
command method-based transfer means for transferring data defining the three-dimensional model based on the drawing instruction, and data defining a display method for displaying the three-dimensional model, to the client, by the command method, when it is determined that the command method is the more efficient in processing efficiency; and
differential image method-based transfer means for generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.

7. A three-dimensional model data transfer method for providing image-drawing data for drawing images of a three-dimensional model to a client connected thereto via a network, comprising:
a three-dimensional model-forming step of forming the three-dimensional model in response to a request from the client, and delivering a drawing instruction for drawing an image of the three-dimensional model;
a data transfer method-determining step of calculating processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency;
a command method-based transfer step of transmitting data defining the three-dimensional model based on the drawing instruction, and data defining a display method for displaying the three-dimensional model, to the client, by the command method, when it is determined that the command method is the more efficient in processing efficiency; and
a differential image method-based transfer step of generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.

8. A computer-readable storage medium that stores a three-dimensional model data-providing program that is used when a computer provides image-drawing data for drawing images of a three-dimensional model to a client connected thereto via a network,
wherein the program causes the computer to function as:
three-dimensional model-forming means for forming the three-dimensional model in response to a request from the client, and delivering a drawing instruction for drawing an image of the three-dimensional model;
data transfer method-determining means for calculating, based on the drawing instruction, processing time periods that a command method in which image-drawing commands are transferred to the client over the network and a differential image method in which data representative of a differential image is transferred to the client over the network will take, respectively, to draw the image of the three-dimensional model on the client, and determining which of the two data transfer methods is the more excellent in processing efficiency;
command method-based transfer means for transferring data defining the three-dimensional model based on the drawing instruction, and data defining a display method for displaying the three-dimensional model, to the client, by the command method, when it is determined that the command method is the more efficient in processing efficiency; and
differential image method-based transfer means for generating a two-dimensional projected image from the three-dimensional model based on the drawing instruction, and transferring a differential image between the generated projected image and an immediately preceding projected image, to the client, by the differential image method, when it is determined that the differential image method is the more efficient in processing efficiency.
